(19) United States
(12) Patent Application Publication
(10) Pub. No.: US 2004/0028066 A1
(43) Pub. Date: Feb. 12, 2004

(54) Receiver architectures with dynamic symbol memory allocation and methods therefor

(76) Inventors: Chris Quanbeck, Harvard, IL (US); Michael Carney, Woodstock, IL (US)

Correspondence Address: MOTOROLA INC, 600 NORTH US HIGHWAY 45, LIBERTYVILLE, IL, 60048-5343, US

(21) Appl. No.: 10/213,629

(22) Filed: Aug. 6, 2002

(51) Int. Cl. H04L 12/28; H04L 12/56

(52) U.S. Cl. 370/412; 370/329

(57) ABSTRACT

A receiver (300) capable of simultaneously receiving a plurality of physical channels is disclosed herein. The receiver includes symbol memory (370) divided into a plurality of partitions, at least one partition corresponding to each of the plurality of channels that the receiver is capable of receiving simultaneously. The symbol memory is preferably not substantially more than a minimum amount required for accommodating the maximum symbol rate received at any particular time. A processor is coupled to the symbol memory for dynamically allocating one or more memory partitions to each physical channel received based upon a corresponding physical channel data rate.

### FIELD OF THE INVENTIONS

The present inventions relate generally to code division multiple access (CDMA) communications, and more particularly receiver architectures, for example those in 3GPP Wideband-CDMA (WCDMA) wireless cellular communication handsets, receivers including dynamic memory allocation, and methods therefor.

### BACKGROUND OF THE INVENTIONS

In typical 1^{st} and 2^{nd} generation cellular communications systems, wireless mobile communication handsets are required to recover only a single physical channel at any instant in time. In 3^{rd} generation (3G) communications systems, for example 3GPP WCDMA systems, however the handsets must demodulate many physical channels simultaneously, or in parallel. The physical channels generally have different classifications, for example DPCH, DSCH, SCCPCH, etc. and may operate at different symbol rates. Thus in 3GPP WCDMA systems each physical channel has potentially different memory requirements. Physical channels with higher symbol rates require more memory, and those with lower rates require less. 3G handsets must also be capable of dynamically assigning and de-assigning physical channels to and from a set of currently assigned physical channels.

In the CDMA IS-95B system, receivers are required to demodulate multiple physical channels operating at the same symbol rate. It is known that in Motorola's 2^{nd} generation CDMA IS-95B communication architectures, all physical channels share the same symbol memory, wherein each physical channel processor sequentially writes symbols from the corresponding channel into the shared memory whenever new symbols become available. The shared memory address is incremented each time a channel processor writes a symbol in a first-in-first-out (FIFO) storage scheme. The Motorola CDMA IS-95B symbol buffering scheme does not require substantial memory, but it will not permit dynamic addition and removal of physical channels, each of which may be operating at a different symbol rate, as is required for 3G communications.

Alternatively, each channel processor may be allocated a corresponding symbol buffer or RAM partition sufficiently large to accommodate the maximum number of symbols that may be assigned to the channel. This will permit dynamic addition and removal of physical channels, but this buffering scheme requires more memory than the theoretical minimum by a factor of N, where N corresponds to the number of parallel channels that may be received.

The various aspects, features and advantages of the present inventions will become more fully apparent to those having ordinary skill in the art upon careful consideration of the following Detailed Description of the Invention with the accompanying drawings described below.

### BRIEF DESCRIPTION OF THE DRAWINGS

FIG. 1 is an electrical circuit schematic block diagram of an exemplary receiver portion.

FIG. 2 is an exemplary symbol memory partitioned into M clusters.

FIG. 3 is an exemplary receiver memory allocation architecture.

FIG. 4 is an exemplary memory mapping structure for dynamically mapping memory clusters to physical channels.

FIG. 5 is an exemplary memory mapping process diagram.

FIG. 6 is an exemplary memory mapping structure.

FIG. 7 is an exemplary partitioned memory.

FIG. 8 is another exemplary memory mapping structure.

FIG. 9 is another exemplary partitioned memory.

### DETAILED DESCRIPTION OF THE INVENTIONS

The present inventions address the problem of allocating symbol buffer memory to parallel physical channels within CDMA receivers, for example those in 3GPP W-CDMA communications systems. The inventions are applicable more generally to dynamically allocating memory to one or more channels based on a change in channel reception requirements.

In general, communication systems contain multiple levels of data channels. The 3GPP WCDMA system, for example, includes physical, transport, and logical data channels. Although the exemplary embodiments of the invention allocate memory partitions to physical channels, memory partitions may also be dynamically allocated to other data channels within the receiver. These and other aspects of the inventions will be discussed more fully below.

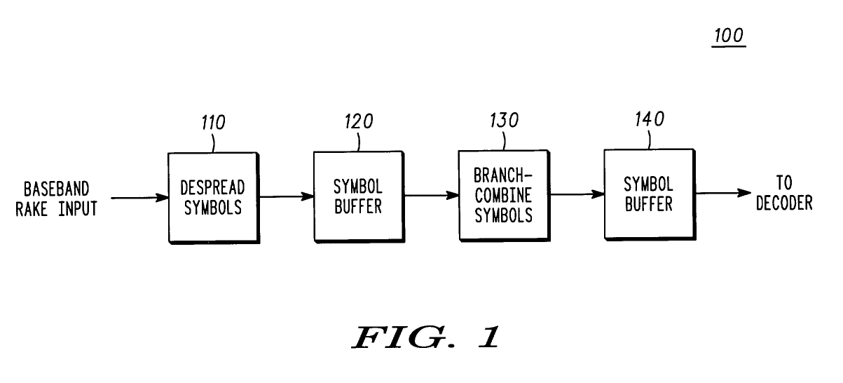

In many communications receiver architectures, for example 3GPP W-CDMA receivers, data buffering is required along one or more points of the receive chain. In the exemplary RAKE receiver 100 of FIG. 1, a baseband input signal is subject to symbol despreading at block 110, the output of which is buffered at block 120. The symbols are combined at block 130, and buffered again at block 140 before decoding.

As noted above, when the reception requirements on one or more of the physical channels change, buffering requirements change accordingly. In 3GPP W-CDMA communication systems, for example, a set consisting of one or more downlink physical channels may be received. The physical channels each may have different symbol rates and are received simultaneously, or in parallel. A change to the reception requirements, which is typically mandated by the communications infrastructure, corresponds to the addition or removal of a channel. In response, different channels are selected and de-selected dynamically within the receiver. A change to the reception requirements may also correspond to a change in the data rate of one or more physical channels.

According to one aspect of the inventions generally, a receiver receives a channel at a data rate that may change, or vary, over time, and the receiver allocates memory to the channel received based on the data rate thereof. In receivers capable of simultaneously receiving multiple channels, each of which may be operating at a different symbol rate, memory is allocated to each of the channels based on the data rate of the corresponding channel. Memory is dynamically re-allocated to one or more channels when the data rate of one or more of the channels changes, or when the received channel set changes, for example by the selection of a new channel or by the de-selection of a currently received channel. The receiver thus uses an adaptive memory assignment scheme based on available memory resources and the requirements of the communications infrastructure.

The dynamic allocation of the memory resource to channels dependent on the data rates thereof permits optimally minimizing the total memory allocated for data buffering. This resource optimization is desirable for many applications, for example mobile wireless communications handsets where size, power and cost constraints are paramount design considerations. All of these constraints are generally affected positively by a reduction in memory.

Thus in some embodiments of the invention, the total symbol memory is not substantially greater than, and is preferably, the minimum amount of memory required to accommodate the maximum number of data symbols that the receiver is capable of receiving at any particular time. In 3GPP WCDMA communications architectures, the theoretical minimum symbol memory requirement is a linear function of the mobile user equipment (UE) radio access capability parameter. The UE reports this parameter to the communications infrastructure base stations as the maximum number of physical channel bits that the receiver is capable of demodulating at an arbitrary instant of time.

In receivers capable of receiving a limited plurality of channels simultaneously, memory is divided into at least as many portions as the number of physical channels the receiver is capable of receiving simultaneously. In one embodiment, the memory partitions constitute a unitary memory entity divided into as many portions as required, and in another embodiment the memory partitions are formed as discrete memory blocks, which may be formed for example on one or more integrated circuits.

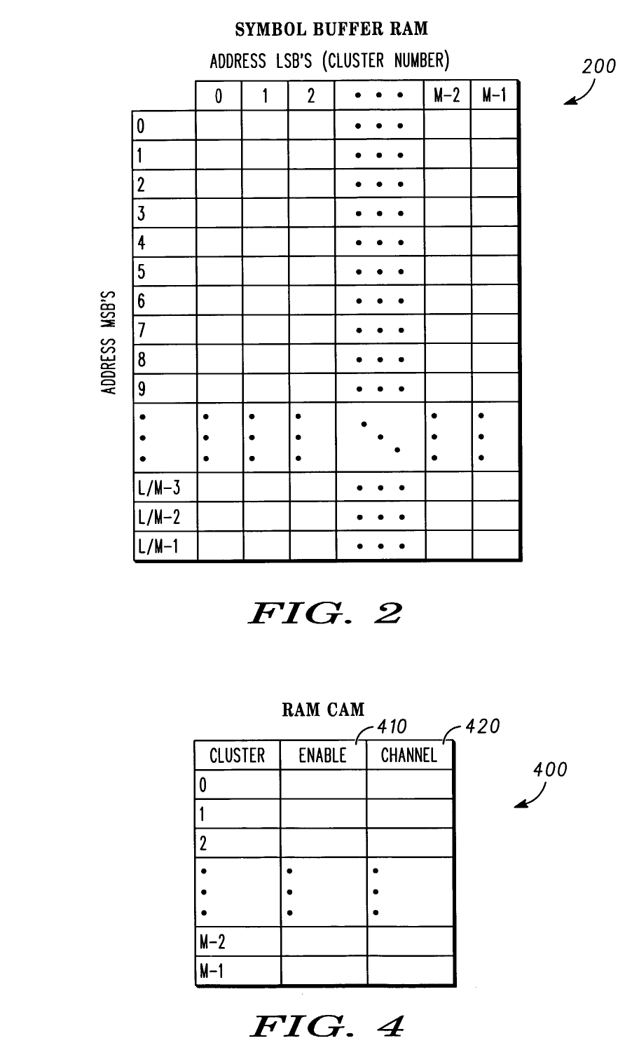

Consider, for example, a RAKE receiver capable of receiving N downlink physical channels in parallel. The symbol memory required for the buffering of symbol information at several points in the RAKE processor chain is divided into a set of M partitions, M>=N, called clusters, which are assignable to a particular physical channel depending on the symbol rate thereof. FIG. 2 illustrates an exemplary symbol buffer RAM 200 partitioned into M clusters, which correspond to the vertical columns 0, 1, 2, 3 . . . M-2 and M-1.

Generally at least one partition, or cluster, is assigned to each channel received. Physical channels with higher symbol rates are assigned more clusters than channels with lower symbol rates. According to this memory allocation scheme, some or all of the clusters may be assigned to one or more channels. In some embodiments, the channels are physical channels, or transport channels, or logical channels, or combinations thereof. At some times, not all clusters are assigned. Several examples are discussed further below.

In embodiments where it is desirable to minimize the amount of data buffer memory, the total memory partitioned, or the summation of the clusters, is equal to the minimum amount of memory required to accommodate the maximum amount of data that the receiver is capable of receiving at any time.

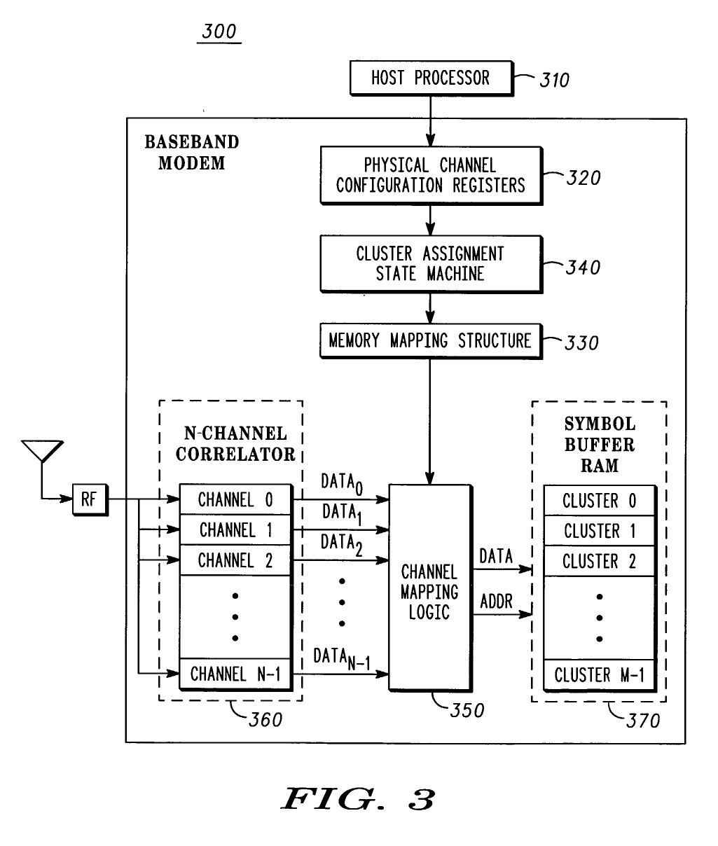

FIG. 3 is a dynamic memory allocation architecture 300 suitable for implementing one embodiment of the invention in a receiver, for example in a multi-channel RAKE receiver. In FIG. 3, a host processor 310 specifies a set of physical channels and their associated symbol rates. The host processor also configures physical channel registers 320. The set specified may include one or many channels, and in some embodiments no channels.

In one embodiment, portions of memory are dynamically allocated to the one or more downlink physical channels to be received. In FIG. 3, the memory mapping structure (330) is a RAM cluster assignment matrix (CAM), which dynamically maps at least one memory partition, or cluster, to a physical channel. The exemplary memory mapping structure 330 may be implemented through RAM or flip-flops.

In FIG. 4, the memory mapping structure 400 comprises M cluster fields, which correspond to the horizontal rows 0, 1, 2, 3 . . . M-2 and M-1. There is at least one field for each memory cluster. In FIG. 4, each cluster field contains a cluster enable field 410 and a physical channel pointer field 420. According to this exemplary memory mapping structure, memory is mapped by enabling and associating enabled clusters with physical channels based on their corresponding data rates. For RAM size L partitioned into M clusters, each cluster consists of L/M addresses. Thus channels requiring more than L/M addresses for symbol buffering are allocated multiple clusters, and channels requiring less than L/M addresses are allocated one cluster, which may not be filled completely.

In the exemplary implementation of FIG. 3, a receiver processor uses the physical channel set and data rate information specified by the host processor 310 as input to a state machine 340 which configures, the memory mapping structure 330 by enabling and associating enabled clusters with the physical channels specified, based upon the corresponding symbol rates of the channels.

The host processor dynamically selects and de-selects physical channels, for example, based on messages from the cellular network. Thus the state machine dynamically configures the memory mapping structure 330 accordingly. For example, the cluster assignment state machine 340 enables and assigns new clusters when new channels are selected and disables clusters when existing channels are de-selected or removed.

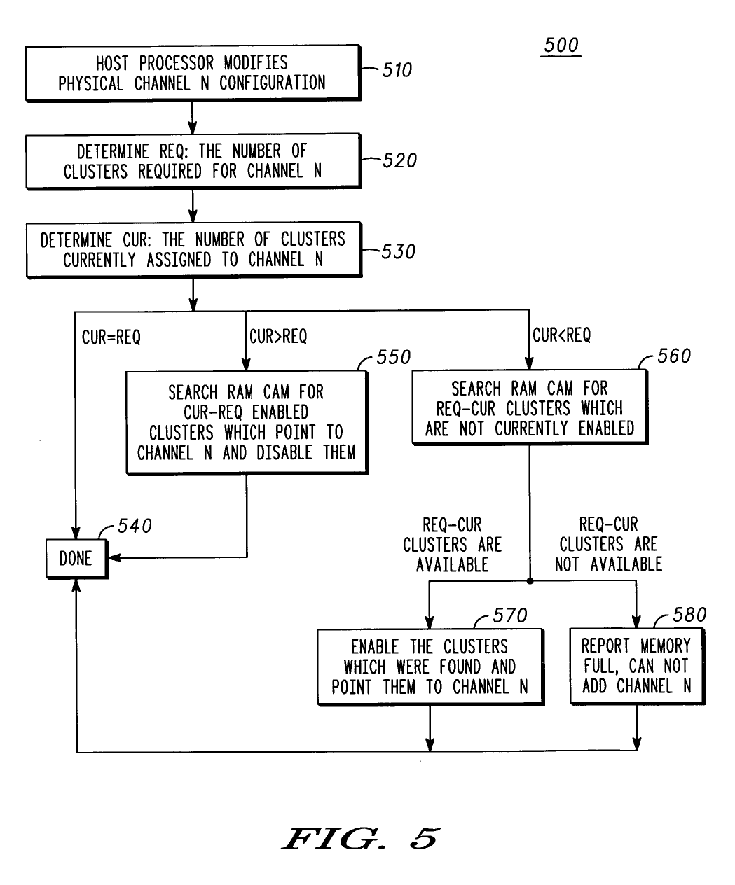

FIG. 5 is a state machine algorithm 500 for configuring the memory mapping structure based on a physical channel set and corresponding data rate information. At block 510, the processor specifies or modifies a physical channel n, for example by adding or removing the channel. At block 520, the number of memory partitions or clusters required for the channel n is determined based on the corresponding data rate. At block 530, the current number of clusters assigned to the channel n is determined. At block 540, if the number of clusters required for the channel is the same as the number currently assigned, no further cluster allocation is required. If the number of clusters required for the channel is less than the number currently assigned, the number of clusters assigned to the channel are disabled at block 550. As a result, these clusters are available for assignment to another channel. If the number of clusters required for the channel is greater than the number currently assigned, an inventory of available clusters is made at block 560. If clusters are available for assignment to the channel n, the allocation is made at block 570. If there are an insufficient number of clusters available, a message will be reported to the host processor and the channel will not be added. Although the exemplary algorithm of FIG. 5 was discussed in the context of a single channel, n, the principles are applicable more generally to many channels.

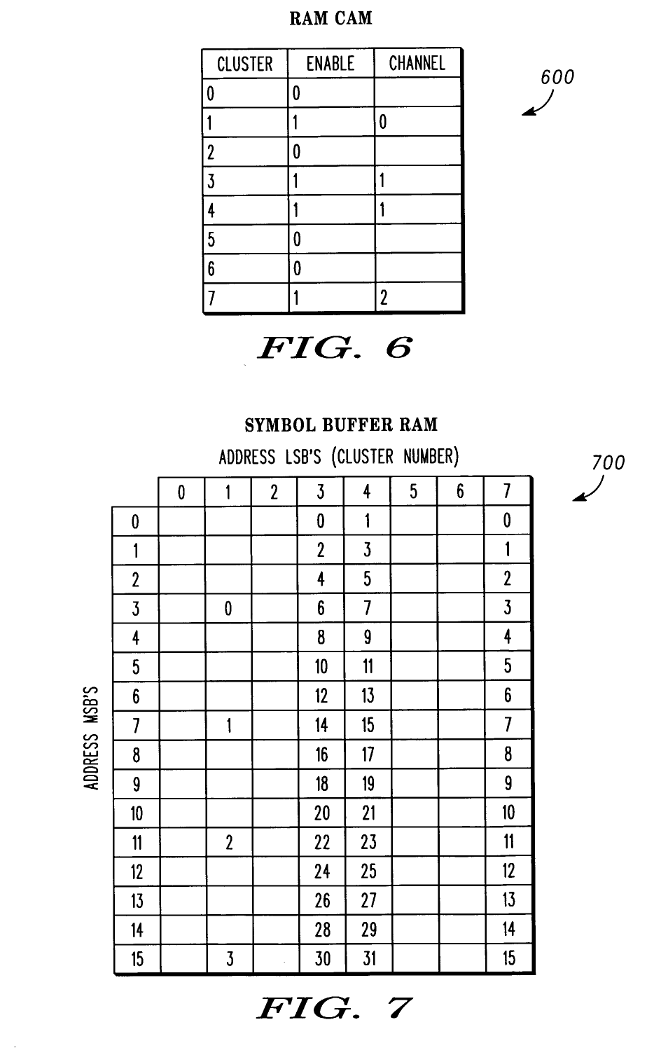

In FIG. 6, clusters 1, 3, 4 and 7 of RAM mapping structure 600 are enabled. Cluster 1 is assigned to channel 0, clusters 3 and 4 are assigned to channel 1, and cluster 7 is assigned to channel 2. It is assumed for this example, that the assigned channels have the following symbol rates:

Channel 0=0.25x symbol rate

Channel 1=2.00x symbol rate

Channel 2=1.00x symbol rate

Where x is a hypothetical base rate requiring L/M=16 locations (1 cluster). FIG. 7 illustrates partitioned memory 700 having cluster 1 assigned to channel 0, which requires only 4 of the 16 available locations. FIG. 7 also illustrates the assignment of memory clusters 3 and 4 to channel 1, and the assignment of memory cluster 7 to channel 2. The numbers in the clusters represent the order in which symbols on a particular channel are received and stored within the cluster corresponding to that channel. In Cluster 1, for example, the symbols are received and stored top to bottom. In clusters 3 and 4, the symbols are received and stored across and down.

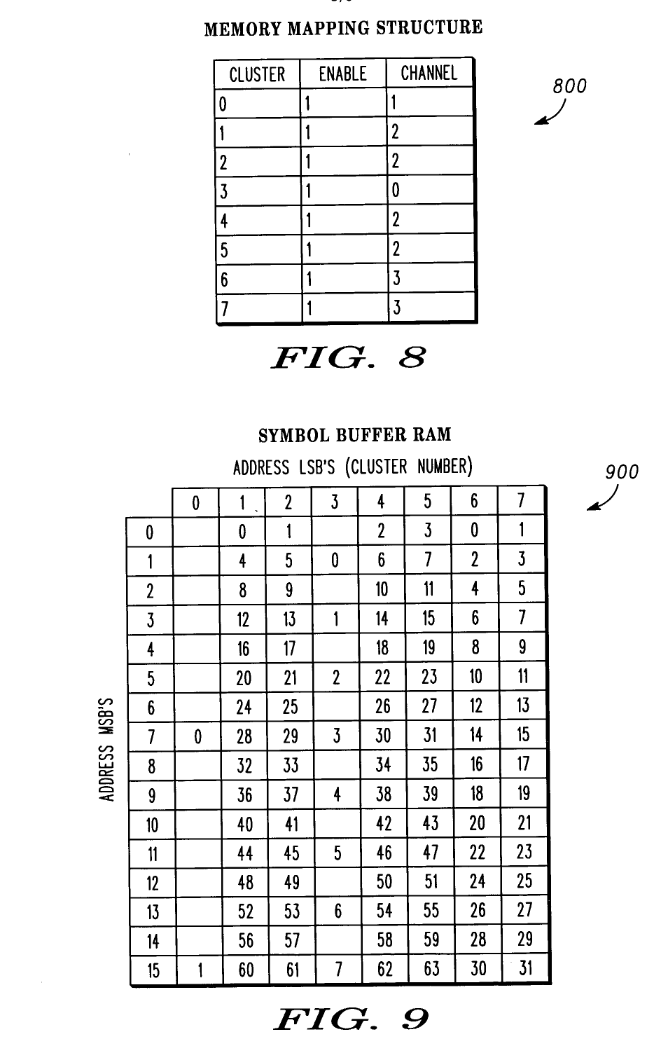

In FIG. 8, clusters 0-7 of RAM mapping structure 800 are enabled. Cluster 0 is assigned to channel 1, clusters 1, 2, 4 and 5 are assigned to channel 2, memory cluster 3 is assigned to channel 0, and clusters 6 and 7 are assigned to channel 3. It is assumed for this example, that the assigned channels have the following symbol rates:

Channel 0=0.500x symbol rate

Channel 1=0.125x symbol rate

Channel 2=4.000x symbol rate

Channel 3=2.000x symbol rate

Where x is a hypothetical base rate requiring L/M=16 locations (1 cluster). The partitioned memory 900 in FIG. 9 has cluster 0 assigned to channel 1, which requires only 2 of the 16 available memory locations, clusters 1, 2, 4 and 5 assigned to channel 2, cluster 3 assigned to channel 0, and clusters 6 and 7 assigned to channel 3.

In FIG. 3, the mapping of the RAM mapping structure 330 is used by channel mapping logic 350 to transfer data from each received physical channel on a channel correlator 360 to the corresponding memory partition in the symbol buffer 370. Particularly, the channel mapping logic 350 generates symbol memory addresses for the physical channels based on the mapping of the memory mapping structure, for example according to the scheme illustrated in FIGS. 7 and 9.

In other embodiments, there may be variations on the exemplary memory mapping structure discussed above. Also, in other embodiments, memory partitions may be dynamically assigned to the physical channels based on the data rates by alternative memory allocation schemes.

In a typical receiver application, channel mapping logic and a corresponding symbol buffer may exist at more than one location in the receiver chain, for example at the despreader and branch combiner, as illustrated in FIG. 1.

While the present inventions and what is considered presently to be the best modes thereof have been described in a manner that establishes possession thereof by the inventors and that enables those of ordinary skill in the art to make and use the inventions, it will be understood and appreciated that there are many equivalents to the exemplary embodiments disclosed herein and that myriad modifications and variations may be made thereto without departing from the scope and spirit of the inventions, which are to be limited not by the exemplary embodiments but by the appended claims.

What is claimed is:

1. A method in a receiver capable of simultaneously receiving a limited number of channels, comprising:
determining a current allocation of memory to channels, each channel at a corresponding symbol rate;
detecting a change to channel reception requirements; and
allocating memory corresponding to the change in the channel reception requirements.

2. The method of claim 1, determining a current allocation of channels by reading a memory mapping structure.

3. The method of claim 1, enabling memory partitions, associating one or more enabled memory partitions to each of the channels based on the channel symbol rate.

4. The method of claim 1, detecting a change to the physical channel reception requirements by detecting a change to the channel symbol rate.

5. The method of claim 1, detecting a change to the channel reception requirements by detecting the addition or removal of a channel.

6. The method of claim 1, allocating memory by determining the number of partitions of memory required for accommodating the change in channel reception requirements and assigning a channel to at least one of the available partitions of memory.

7. The method of claim 1,
allocating memory by determining a number of partitions of memory available for assignment,
determining the number of partitions of memory required to accommodate the change in channel reception requirements, and
assigning a channel to at least one of the available partitions of memory.

8. The method of claim 1, partitioning a memory of the receiver into at least as many partitions as the limited number of physical channels the receiver is capable of receiving simultaneously.

9. A method in a receiver capable of receiving a limited number of physical channels in parallel, comprising:
receiving a physical channel at corresponding symbol rate;
allocating at least a portion of total symbol memory to the physical channel received based on the symbol rate of the physical channel,
the total symbol memory is not substantially more than a minimum amount of memory required to accommodate the maximum number of symbols that the receiver is capable of receiving at a particular time.

10. The method of claim 9, receiving the physical channel at a variable symbol rate, re-allocating the symbol memory to the physical channel received based on the variable symbol rate of the physical channel.

11. The method of claim 9, simultaneously receiving a plurality of physical channels at corresponding symbol rates, allocating portions of the total symbol memory to the physical channels received based on the corresponding symbol rates of the physical channels.

12. The method of claim 9, dynamically adding and removing physical channels received at a particular time, re-allocating portions of the total symbol memory to the physical channels received based on the corresponding symbol rates of the physical channels.

13. The method of claim 9, allocating at least a portion of total symbol memory to the physical channel received by mapping at least a portion of the total memory to the physical channel in a memory mapping structure.

14. The method of claim 9,
receiving a single physical channel at maximum symbol rate;
allocating the total symbol memory to the single physical channel received based on the symbol rate of the physical channel.

15. A method in a receiver, comprising:
specifying a set of physical channels to be received simultaneously and corresponding data rates,
mapping memory to each physical channel specified based on the data rate of the corresponding physical channel;
buffering data on each physical channel received in the corresponding portion memory based on the memory mapping.

16. The method of claim 15, mapping memory to each physical channel specified by enabling portions of memory and associating the enabled memory portions with the physical channels specified based on the data rate of the corresponding physical channel.

17. The method of claim 15,
re-specifying the set of physical channels to receive simultaneously,
re-mapping memory to each physical channel re-specified based on the data rate of the corresponding physical channel;
buffering data on each physical channel in the corresponding portion memory.

18. The method of claim 15, the receiver is capable of receiving a limited number of channels simultaneously, partitioning the memory into at least as many partitions as the number of channels the receiver is capable of receiving simultaneously.

19. The method of claim 18, partitioning the memory by partitioning a minimum amount of memory required to accommodate a maximum amount of data that the receiver is capable of receiving at any particular time.

20. A multi-channel receiver, comprising:
memory divided into a plurality of partitions, at least one partition for each channel of the receiver;
a memory mapping structure, the memory mapping structure having a plurality of fields, a field of the memory mapping structure corresponding to each memory partition;
a processor for dynamically associating fields of the memory mapping structure with channels of the receiver based on corresponding data rates of the channels.

21. The receiver of claim 20,
the processor for specifying a set of channels and corresponding data rates,
the processor for associating the fields of the memory mapping structure with the channels specified based on the corresponding data rates of the channels specified.

22. The receiver of claim 20, memory control logic coupled to the memory and to the memory mapping structure, the memory control logic for generating memory addresses based on the association of the fields of the memory mapping structure with the channels of the receiver.

23. The receiver of claim 20, a total sum of the memory partitions is not substantially more than a minimum amount of memory required for storing a maximum amount of data received at a particular time.

24. A receiver capable of simultaneously receiving a plurality of channels, comprising:
a total amount of symbol memory divided into a plurality of partitions, at least one partition corresponding to each of the plurality of channels that the receiver is capable of receiving simultaneously;
the total amount of symbol memory is a minimum amount of symbol memory required to store a maximum amount of symbols received at a particular time;
a processor coupled to the symbol memory,
the processor for allocating one or more memory partitions to each channel received based upon a corresponding channel data rate.

25. The receiver of claim 24,
the processor for specifying to the receiver processor a set of channels and corresponding data rates,
the processor for allocating symbol memory partitions to the channels specified based on the corresponding data rates of the channels specified.

26. The receiver of claim 24, memory control logic coupled to the symbol memory and to the processor, the memory control logic for generating memory addresses based on the allocation of memory partitions to each channel received.
